(19) United States
(12) Patent Application Publication
(10) Pub. No.: US 2023/0162054 A1
(43) Pub. Date: May 25, 2023

(54) NON-TRANSITORY COMPUTER-READABLE RECORDING MEDIUM, MACHINE TRAINING METHOD, AND INFORMATION PROCESSING APPARATUS

(71) Applicant: FUJITSU LIMITED, Kawasaki-shi (JP)

(72) Inventor: Seiji OKAJIMA, Kawasaki (JP)

(73) Assignee: FUJITSU LIMITED, Kawasaki-shi (JP)

(21) Appl. No.: 18/093,342

(22) Filed: Jan. 5, 2023

Related U.S. Application Data
(63) Continuation of application No. PCT/JP2020/029718, filed on Aug. 3, 2020.

(51) Int. Cl. G06N 5/022

(52) U.S. Cl. CPC G06N 5/022

(57) ABSTRACT

An apparatus determines which of the first triple and the second triple is associated with more specific information based on a first comparison between a first relation between first two entities included in the first triple and a second relation between second two entities included in the second triple according to an occurrence status of each of relations between entities in a specific set of classes included in the knowledge graph and a second comparison between a first entity connected to any one of the first two entities and a second entity connected to any one of the second two entities, and generates vectors representing elements of the first triple and vectors representing elements of the second triple by machine learning based on a constraint that a difference in the vectors of the first triple is smaller than a difference in the vectors of the second triple.

### CROSS-REFERENCE TO RELATED APPLICATION

This application is a continuation of International Application No. PCT/JP2020/029718, filed on Aug. 3, 2020, the entire contents of which are incorporated herein by reference.

### FIELD

The embodiments discussed herein are related to machine learning based on a knowledge graph.

### BACKGROUND

A knowledge graph (KG) is embedded in a vector space to represent nodes (entities) and links (relations) in the knowledge graph by vectors. Such a vector representation is also called an embedded representation. The knowledge graph is also an example of knowledge data attached with knowledge by an ontology, which is generalized level of knowledge (class) and has a hierarchical structure, and an instance which is concrete example level of knowledge and has a graph structure.

Machine learning using such a KG vector representation has been used to give the relationship between entities by a vector representation. For example, the machine learning is performed so that vectors (vₕ, vᵣ, vₜ) corresponding to a triple (subject, predicate, object)=(h: starting point, r: relation, t: end point), which is a set of three elements included in the given KG, satisfies “vₕ+vᵣ=vₜ”, and the vectors of entities and the vectors of relations are updated. By using the vectors generated by such machine learning, link prediction, relation extraction, class prediction, and the like are performed.

For example, the link prediction is an operation that predicts entities with relationships by using entities and links, and for example, predicts the vector “end point” by inputting the vector “starting point” and the vector “relation” into a model. The relation extraction is an operation that predicts, from two entities, the relationship therebetween, and for example, predicts the vector “relation” by inputting the vector “starting point” and the vector “end point” into a model. The class prediction is an operation that predicts, from two entities, a class to which they belong, and for example, predicts a vector “class” by inputting the vector “starting point” and the vector “end point” into a model.

In recent years, machine learning methods that introduce constraints using the entailment relation between relations into embedding calculations (vector calculations) are known as a way to increase the accuracy of models. Specifically, when there is a relation q between given entities e1 and e2 and there is always a relation r (r entails q), each vector is updated so that the score of a triple (e1, q, e2) is higher than the score of a triple (e1, r, e2). A conventional technology is described in Boyang Ding et al, “Improving Knowledge Graph Embedding Using Simple Constraints”, ACL 2018, for example.

### SUMMARY

According to an aspect of an embodiment, a non-transitory computer-readable recording medium stores therein a program that causes a computer to execute a process. The process includes specifying a first triple and a second triple included in a knowledge graph, determining which of the first triple and the second triple is associated with more specific information on the basis of at least one of a first comparison and a second comparison, the first comparison being a comparison between a first relation between first two entities included in the first triple and a second relation between second two entities included in the second triple according to an occurrence status of each of a plurality of relations between a plurality of entities in a specific set of classes included in the knowledge graph, the second comparison being a comparison between a first entity connected to any one of the first two entities and a second entity connected to any one of the second two entities, and when it is determined by the determining that the first triple is associated with the more specific information, generating vectors representing elements of the first triple and vectors representing elements of the second triple by machine learning based on a constraint that a difference in the vectors representing the elements of the first triple is smaller than a difference in the vectors representing the elements of the second triple.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an information processing apparatus according to an example;

FIG. 2 is a diagram for explaining a knowledge graph;

FIG. 3 is a diagram for explaining a reference technology;

FIG. 4 is a diagram for explaining problems of the reference technology;

FIG. 5 is a diagram for explaining problems of the reference technology;

FIG. 6 is a functional block diagram illustrating the functional configuration of an information processing apparatus according to a first example;

FIG. 7 is a diagram illustrating an example of a knowledge graph;

FIG. 8 is a diagram for explaining vector generation according to the first example;

FIG. 9 is a flowchart illustrating the flow of a vector generation process according to the first example;

FIG. 10 is a diagram for explaining vector generation according to a second example;

FIG. 11 is a flowchart illustrating the flow of a vector generation process according to the second example;

FIG. 12 is a flowchart illustrating the generic flow of a vector generation process using a class pair;

FIG. 13 is a flowchart illustrating the generic flow of a vector generation process using a class hierarchy; and

FIG. 14 is a diagram for explaining a hardware configuration example.

### DESCRIPTION OF EMBODIMENTS

However, the above conventional technology do not always provide a highly accurate vector representation acquired using a model.

For example, the above conventional technology give higher scores to a triple including a relation (target) with a low abstraction level, but the accuracy of vector representations may decrease in unorganized knowledge graphs. For example, targets may be commonly used by different classes of entities, but there are cases where the above conventional technology is not able to find a relation that entails the target and is not able to apply the constraint accurately, which reduces training accuracy. Furthermore, the above conventional technology deal with the abstraction level of relations, but is not able to deal with the abstraction level of entities, so the accuracy of models generated is not always as high as expected.

Preferred embodiments will be explained with reference to accompanying drawings. These examples do not limit the invention. The examples can be appropriately combined without causing a contradiction.

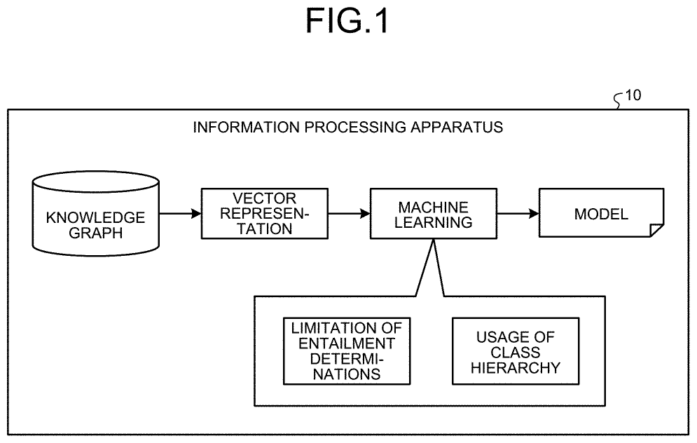

FIG. 1 is a diagram for explaining an information processing apparatus 10 according to an example. As illustrated in FIG. 1, the information processing apparatus 10 is an example of a computer that generates vector representations accurately indicating relations between entities by representing entities and relations in a knowledge graph by vectors and performing machine learning by using the generated vector representations.

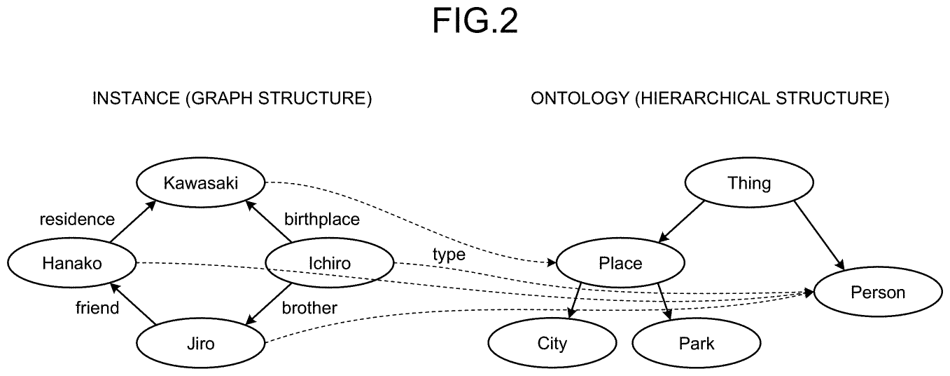

The knowledge graph is an example of knowledge data having ontologies and instances. FIG. 2 is a diagram for explaining the knowledge graph. As illustrated in FIG. 2, the ontology of the knowledge graph is generalized level of knowledge and has a hierarchical structure. For example, a class “Place” and a class “Person” correspond to low-level layers (subconcept) of a class “Thing”. A class “City” and a class “Park” correspond to a low-level layer of the class “Place”.

The instance of the knowledge graph is concrete example level of knowledge and has a graph structure. For example, an entity “Hanako” is connected to an entity “Kawasaki” by a relation “residence”, and an entity “Jiro” is connected to the entity “Hanako” by a relation “friend”. An entity “Ichiro” is connected to the entity “Kawasaki” by a relation “birthplace”, and is connected to the entity “Jiro” by a brother relation. The entity “Kawasaki” belongs to the class “Place”, and therefore has a relation “type” between the class “Place” and the entity “Kawasaki”. Similarly, the entities “Hanako”, “Jiro”, and “Ichiro” belong to the class “Person” and each have the class “Person” and the relation “type”.

In a reference technology using a technology called TransE, which is a kind of Translation-based model, machine learning is performed so that vectors (vₕ, vᵣ, vₜ) corresponding to a triple (h, r, t), which is a set of three elements included in a given knowledge graph, satisfies “vₕ+vᵣ=vₜ”, and the vectors of entities and the vectors of relations are updated. In this case, the reference technology introduces constraints using the entailment relation between relations into vector calculations (embedding calculations).

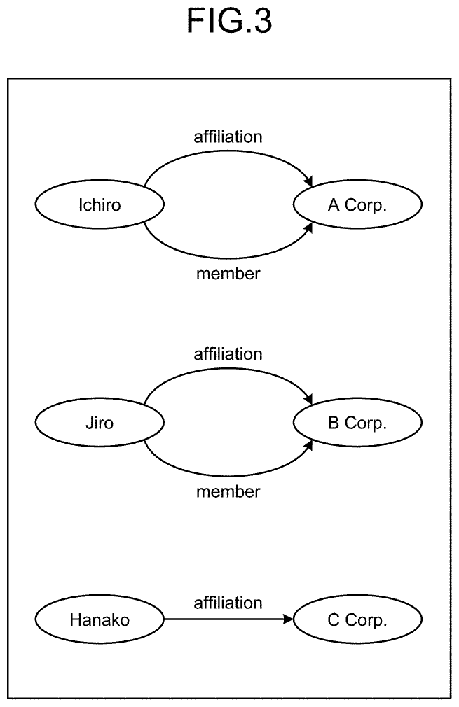

FIG. 3 is a diagram for explaining the reference technology. When a knowledge graph illustrated in FIG. 3 is given, for example, the reference technology performs machine learning assuming that when there is a relation “member” between given entities, there is always a relation “affiliation” and the relation “affiliation” entails the relation “member”. Specifically, the reference technology updates each vector so that v(Ichiro)+v(member) is closer to v(A Corp.) than v(Ichiro)+v(affiliation) and v(Jiro)+v(member) is closer to v(B Corp.) than v(Jiro)+v(affiliation). That is, the reference technology gives higher scores to a triple including a relation with a lower abstraction level. Note that v(Ichiro) is synonymous with vector (Ichiro), and in order to simplify the description, in this example, vector (Ichiro) and the like may be denoted as v(Ichiro) and the like.

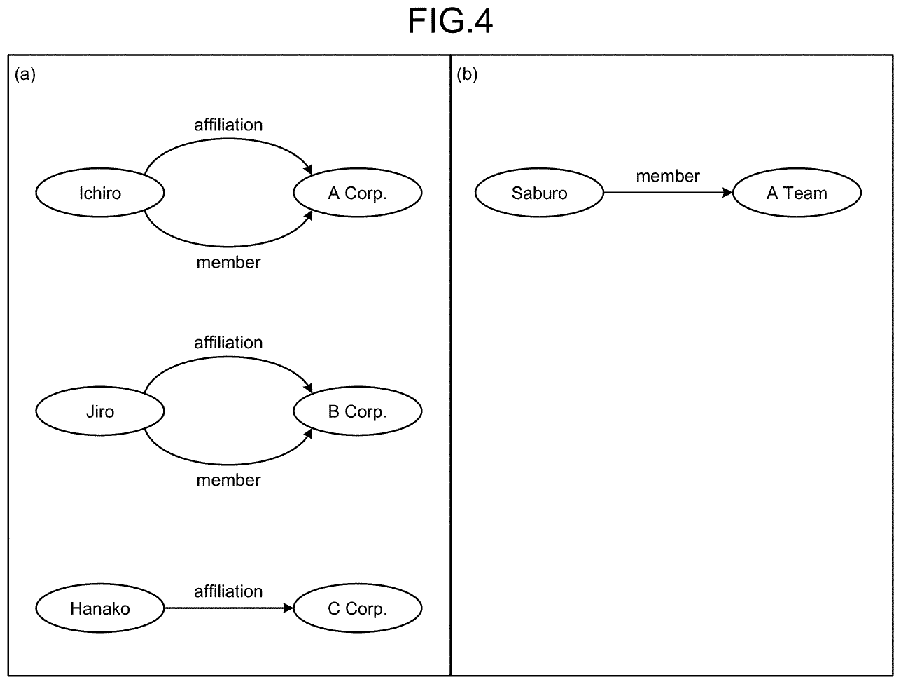

This reference technology performs machine learning by giving higher scores to a triple including a relation and a target with a low abstraction level, but in an unorganized knowledge graph, targets may be commonly used by different classes of entities. There is a case where the reference technology does not find a relation that entails the target and constraints are not able to be properly applied. FIG. 4 is a diagram for explaining problems of the reference technology. Since FIG. 4(a) illustrates a relation between a class with the relation “affiliation” and an attribute value, constraints using the entailment relation between the relations can be introduced into the vector calculation. On the other hand, in FIG. 4(b), the above constraints are not able to be applied because there is data having the relation “member” but not having the relation “affiliation”, so machine learning using such a vector representation may cause a decrease in training accuracy.

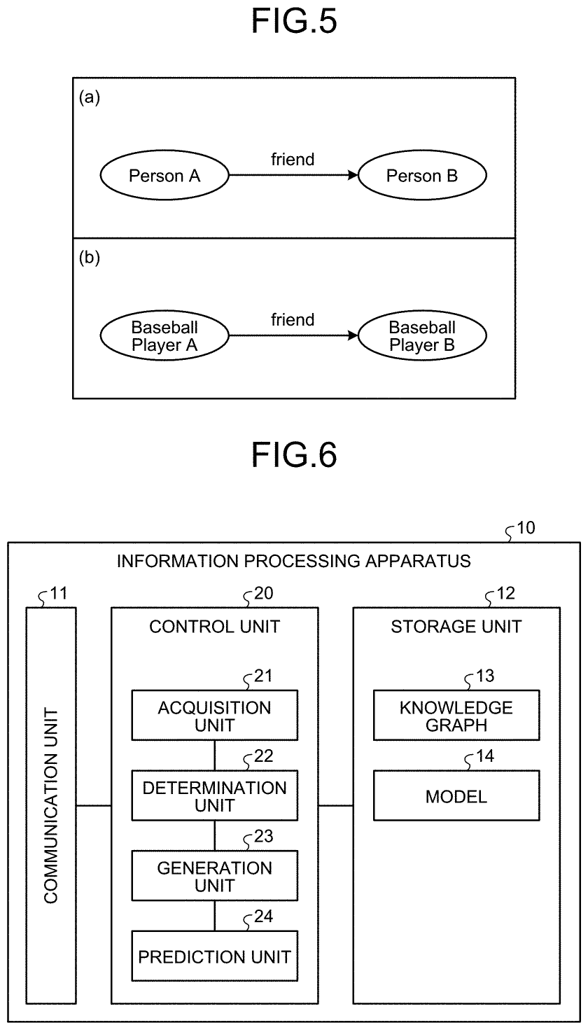

Furthermore, the reference technology deals with the abstraction level of relations, but is not able to deal with the abstraction level of entities. For example, it may be conceivable to focus more on the fact that a baseball player and a basketball player are friends than on the fact that one person and another person are friends. FIG. 5 is a diagram for explaining problems of the reference technology. In the knowledge graph illustrated in FIG. 5, an entity “Person A” and an entity “Person B” have a relation “friend” (see FIG. 5(a)), and an entity “Baseball Player A” and an entity “Baseball Player B” have a relation “friend” (See FIG. 5(b)). In this case, it is intended to perform machine learning assuming that “v(Baseball Player A)+v(Friend)=v(Baseball Player B)” illustrated in FIG. 5(b) is more important than “v(Person A)+v(Friend)=v(Person B)” illustrated in FIG. 5(a). However, since the reference technology is not able to accurately distinguish the abstraction levels of these entities and reflect the abstraction levels in the machine learning, the machine learning is not performed to the extent that the abstraction levels of these entities can be distinguished, so that training accuracy is not as high as expected.

Therefore, in the example, ontology-based constraints are introduced in machine learning based on a knowledge graph to improve the accuracy of vector calculation. Specifically, as illustrated in FIG. 1, the example uses either or both of (first method) limitation of entailment determinations and (second method) usage of class hierarchy to improve the accuracy of machine learning and generate highly accurate vector representations. In a first example, the first method is specifically described, and in a second example, the second method is specifically described.

First, the information processing apparatus 10 using the first method is described. FIG. 6 is a functional block diagram illustrating the functional configuration of the information processing apparatus 10 according to the first example. By limiting the range of an entailment determination based on a class pair when performing the entailment determination on a relation belonging to each class pair, the information processing apparatus 10 implements a vector representation, which properly introduces an entailment relation of the relationship between entities, and machine learning, even for unorganized knowledge graphs.

As illustrated in FIG. 6, the information processing apparatus 10 according to the first example includes a communication unit 11, a storage unit 12, and a control unit 20. The communication unit 11 controls communication with other devices. For example, the communication unit 11 receives knowledge graphs, various information, and instructions to start each process, and the like from an administrator terminal and the like, and displays training results, prediction results, and the like on the administrator terminal.

The storage unit 12 stores therein various data, computer programs to be executed by the control unit 20, and the like. For example, the storage unit 12 stores therein a knowledge graph 13 and a model 14. Note that the storage unit 12 can also store therein intermediate data and the like generated while the control unit 20 performs processing.

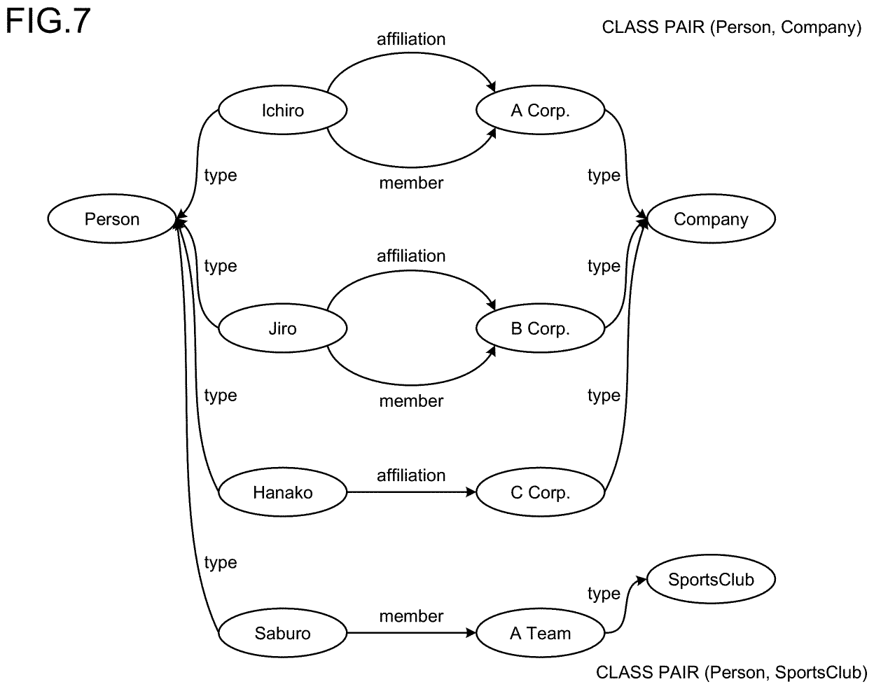

The knowledge graph 13 is an example of a knowledge base including ontologies and instances. FIG. 7 is a diagram illustrating an example of the knowledge graph 13. As illustrated in FIG. 7, the knowledge graph 13 includes a class pair (Person, Company) and a class pair (Person, SportsClub).

The class “Person” includes an entity “Ichiro”, an entity “Jiro”, an entity “Hanako”, and an entity “Saburo”. The class “Company” includes an entity “A Corp.”, an entity “B Corp.”, and an entity “C Corp.”. The class “SportsClub” includes an entity “A Team”.

The entity “Ichiro” is connected to the entity “A Corp.” by a relation “affiliation”, and is connected to the entity “A Corp.” by a relation “member”. The entity “Jiro” is connected to the entity “B Corp.” by a relation “affiliation”, and is connected to the entity “B Corp.” by a relation “member”. The entity “Hanako” is connected to the entity “C Corp.” by a relation “affiliation”. The entity “Saburo” is connected to the entity “A Team” by a relation “member”.

The model 14 is a model used for machine learning of vector representations. For example, the model 14 is a translation-based model for complementing the knowledge graph, and is a model for obtaining vectors of continuous values indicating entities and relations.

The control unit 20 is a processing unit that controls the entire information processing apparatus 10, and includes an acquisition unit 21, a determination unit 22, a generation unit 23, and a prediction unit 24.

The acquisition unit 21 acquires the knowledge graph 13 and stores the knowledge graph 13 in the storage unit 12. For example, the acquisition unit 21 acquires the knowledge graph 13 from a designated acquisition destination, and acquires the knowledge graph 13 transmitted from the administrator terminal and the like.

When determining the entailment relation of each class in the knowledge graph, the determination unit 22 performs an entailment determination by limiting the range of the entailment determination based on the class pair. Specifically, the determination unit 22 specifies a first triple and a second triple included in the knowledge graph. Then, the determination unit 22 compares a first relation between first two entities included in the first triple with a second relation between second two entities included in the second triple according to the occurrence status of each of a plurality of relations between a plurality of entities in a specific set of classes included in the knowledge graph 13. Then, the determination unit 22 determines which of the first triple and the second triple is associated with more specific information.

For example, the determination unit 22 enumerates triples belonging to a certain class pair, and, for all relations included in the enumerated triples, enumerates subject-predicate pairs having the relations. Then, for each pair, the determination unit 22 determines that an entailment relation holds when subject-predicate combinations of one relation include all subject-predicate combinations of the other relation.

When FIG. 7 is described as an example, the determination unit 22 extracts (Ichiro, affiliation, A Corp.), (Ichiro, member, A Corp.), (Jiro, affiliation, B Corp.), (Ichiro, member, B Corp.), and (Hanako, affiliation, C Corp.) as triples belonging to (Person, Company). Subsequently, the determination unit 22 generates “affiliation: (Ichiro, A Corp.), (Jiro, B Corp.), (Hanako, C Corp.)” and “member: (Ichiro, A Corp.), (Jiro, B Corp.)” as relations included in the triples belonging to (Person, Company). As a result, the determination unit 22 determines that the relation “affiliation” entails the relation “member” because all (subject, predicate) included in the relation “member” are included in the relation “affiliation”.

When it is determined that the first triple is associated with the more specific information, the generation unit 23 performs machine learning based on the knowledge graph 13 and the model 14 under the constraint that the difference in vectors representing elements of the first triple is smaller than the difference in vectors representing elements of the second triple, and generates vectors of entities and vectors of relations.

For example, when there is a relation q between given entities e1 and e2 (e1 belongs to C1 and e2 belongs to C2) belonging to a class pair (C1, C2) and there is always a relation r (r entails q), the generation unit 23 updates each vector so that the score of a triple (e1, q, e2) is higher than the score of a triple (e1, r, e2).

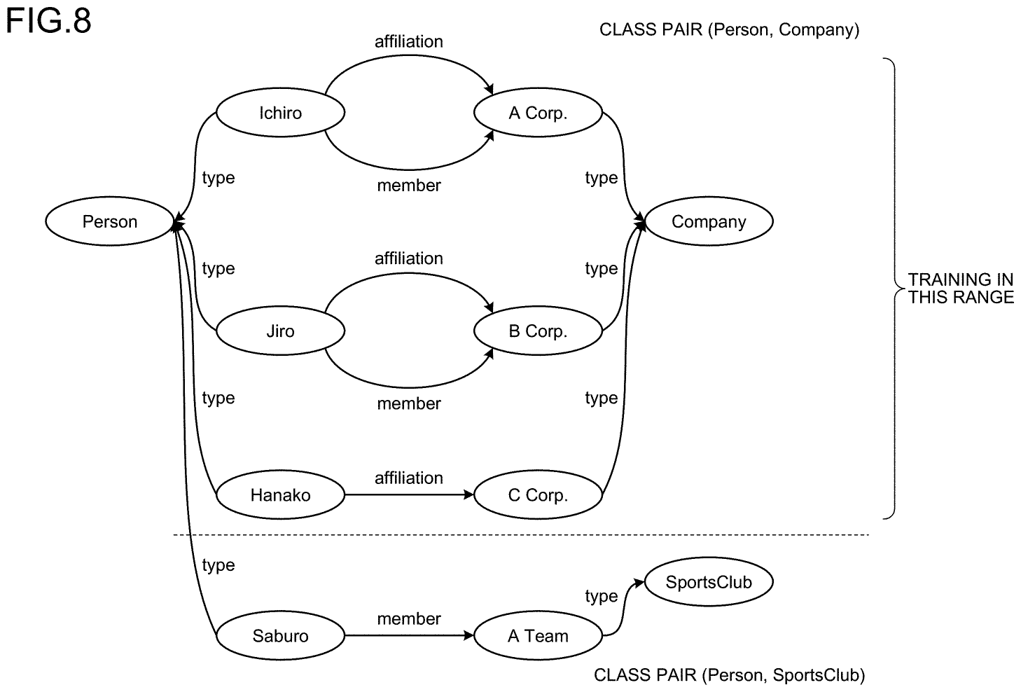

FIG. 8 is a diagram for explaining vector generation according to the first example. With reference to FIG. 8, machine learning using the knowledge graph 13 described in FIG. 7 is described. As illustrated in FIG. 8, for the class pair (Person, Company), the generation unit 23 performs machine learning with more emphasis on the relation “member”, which is a more specific relation, because it has been determined that the relation “affiliation” entails the relation “member”.

For example, for the triple (Ichiro, affiliation, A Corp.) and the triple (Ichiro, member, A Corp.), the generation unit 23 updates vectors so that “v(Ichiro)+v(member) is closer to v(A Corp.) than v(Ichiro)+v(affiliation)”. Similarly, for the triple (Jiro, affiliation, B Corp.) and the triple (Jiro, member, B Corp.), the generation unit 23 updates vectors so that “v(Jiro)+v(member) is closer to v(B Corp.) than v(Jiro)+v(affiliation)”.

In this way, for each triple of each class pair, the generation unit 23 performs machine learning based on the knowledge graph 13 and the model 14 to generate vectors of entities and vectors of relations. Various methods including a gradient method and the like can be used as a machine learning method.

The prediction unit 24 performs link prediction, relation extraction, class prediction, and the like by using the model 14 and the like. Specifically, the prediction unit 24 predicts the vector (end point) by inputting the vector (starting point) and the vector (relation) to the model 14. The prediction unit 24 also predicts the vector (relation) by inputting the vector (starting point) and the vector (end point) to the model.

For example, when predicting an entity connected to the entity “Ichiro” by a relation “brotherOf”, the prediction unit 24 inputs the vector “v(Ichiro)” of the entity “Ichiro” and the vector “v(brotherOf)” of the relation “brotherOf” to the model 14. Then, the prediction unit 24 acquires, as a prediction result, a result that is output by the execution of a vector operation “v(Ichiro)+v(brotherOf)” and the like by the model 14. Then, the prediction unit 24 stores the prediction result in the storage unit 12, displays the prediction result on a display and the like, or transmits the prediction result to the administrator terminal.

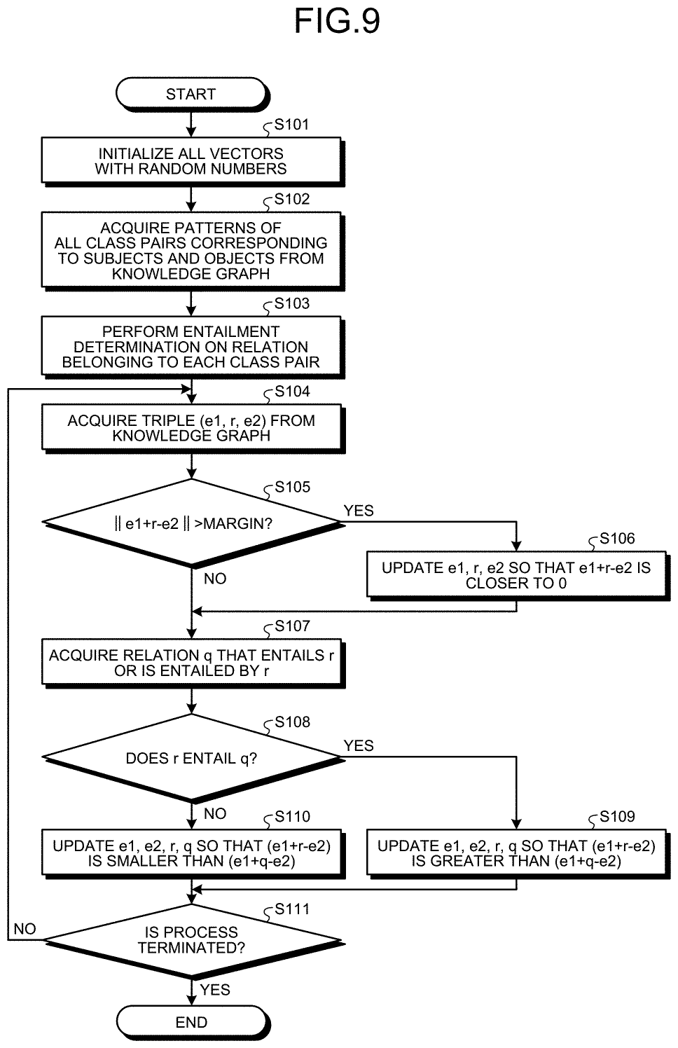

FIG. 9 is a flowchart illustrating the flow of a vector generation process according to the first example. As illustrated in FIG. 9, the determination unit 22 initializes all vectors in the knowledge graph with random numbers (S101), and acquires patterns of all class pairs corresponding to subjects and objects from the knowledge graph (S102). Subsequently, the determination unit 22 performs an entailment determination on a relation belonging to each class pair (S103).

Subsequently, the generation unit 23 acquires the triple (e1, r, e2) from the knowledge graph (S104), and determines whether the vector magnitude “∥e1+r−e2∥” of the triple is greater than a threshold value (Margin) (S105).

When “∥e1+r−e2∥” is greater than the threshold value (Yes at S105), the generation unit 23 updates the vectors of “e1, r, e2” so that the vector difference (e1+r−e2) is closer to 0 (S106).

After S106 is performed or when “∥e1+r−e2∥” is less than the threshold value (No at S105), the generation unit 23 acquires the relation q that entails the relation r or is entailed by the relation r (S107).

When the relation r entails the relation q (Yes at S108), the generation unit 23 updates the vectors of “e1, r, e2” so that the vector difference (e1+r−e2) is greater than the score of the vector difference (e1+q−e2) (S109).

On the other hand, when the relation r does not entail the relation q (No at S108), the generation unit 23 updates the vectors of “e1, r, e2” so that the vector difference (e1+r−e2) is smaller than the vector difference (e1+q−e2) (S110).

Subsequently, the generation unit 23 terminates the process when there is no vector to be updated or when the process has been repeated a prescribed number of times (Yes at S111). When there is a vector to be updated or when the number of times of execution is less than the prescribed number (No at S111), the generation unit 23 repeats S104 and subsequent steps.

As described above, by determining the entailment of a relation for each class pair, the information processing apparatus 10 according to the first example can appropriately distinguish an entailment relation of the relationship between entities and reflect the entailment relation in machine learning with respect to relations used between a plurality of class pairs even though they have a relation with a low abstraction level. As a result, the information processing apparatus 10 can generate highly accurate vector representations.

Next, in the second example, the second method using a class hierarchy is described. The functional configuration of the information processing apparatus 10 according to the second example is the same as in the first example, so a detailed description thereof is omitted. The information processing apparatus 10 according to the second example applies constraints using the class hierarchy during machine learning of vector representations.

Specifically, the determination unit 22 compares a first entity connected to any one of the first two entities with a second entity connected to any one of the second two entities and determines which of the first triple and the second triple is associated with more specific information.

When it is determined that the first triple is associated with the more specific information, the generation unit 23 performs machine learning based on the knowledge graph 13 and the model 14 under the constraint that the difference in vectors representing elements of the first triple is smaller than the difference in vectors representing elements of the second triple. Specifically, when a class C′1 is a subconcept of a class C1 and a class C′2 is a subconcept of a class C2, the generation unit 23 updates vectors of entities (e1, e2) belonging to (C1, C2) and entities (e1′, e2′) belonging to (C′1, C′2) so that the score of a triple (e1′, r, e2′) is higher than the score of the triple (e1, r, e2).

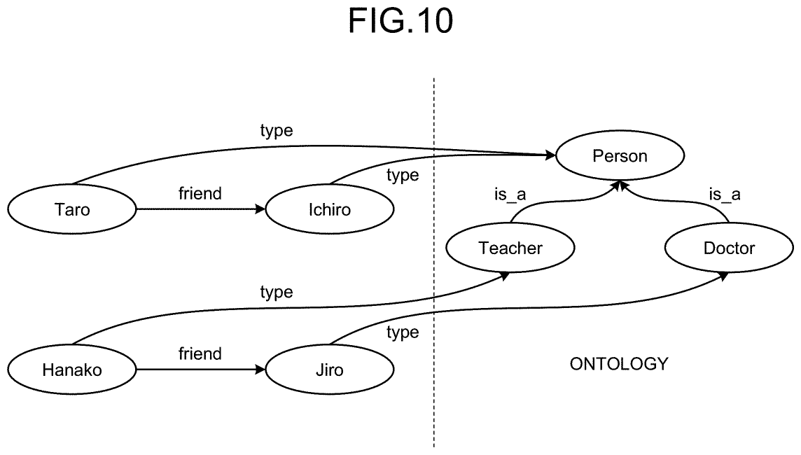

The second example is described in detail with reference to FIG. 10. FIG. 10 is a diagram for explaining vector generation according to the second example. A knowledge graph illustrated in FIG. 10 includes a class “Person”, a class “Teacher”, and a class “Doctor” as an ontology. The class “Person” is a high-level layer (high-level class), and the class “Teacher” and the class “Doctor” are each low-level layers (low-level classes) of the class “Person”.

The knowledge graph also includes an entity “Taro”, an entity “Ichiro”, an entity “Hanako”, and an entity “Jiro” as an instance. The entity “Taro” and the entity “Ichiro” belong to the class “Person” and have a relation “friend”. The entity “Hanako” belong to the class “Teacher” and the entity “Jiro” belong to the class “Doctor” and have a relation “friend”.

In the case of FIG. 10, the determination unit 22 specifies that the class “Teacher” of the entity “Hanako” is a subconcept of the class “Person” of the entity “Taro” and the class “Doctor” of the entity “Jiro” is a subconcept of the class “Person” of the entity “Ichiro”. Therefore, the generation unit 23 updates vectors so that the score of the triple (Hanako, friend, Jiro) is higher than that of the triple (Taro, friend, Ichiro). That is, the generation unit 23 updates the vectors so that “v(Hanako)+v(friend)=v(Jiro)” is greater than “v(Taro)+v(friend)=v(Ichiro)”.

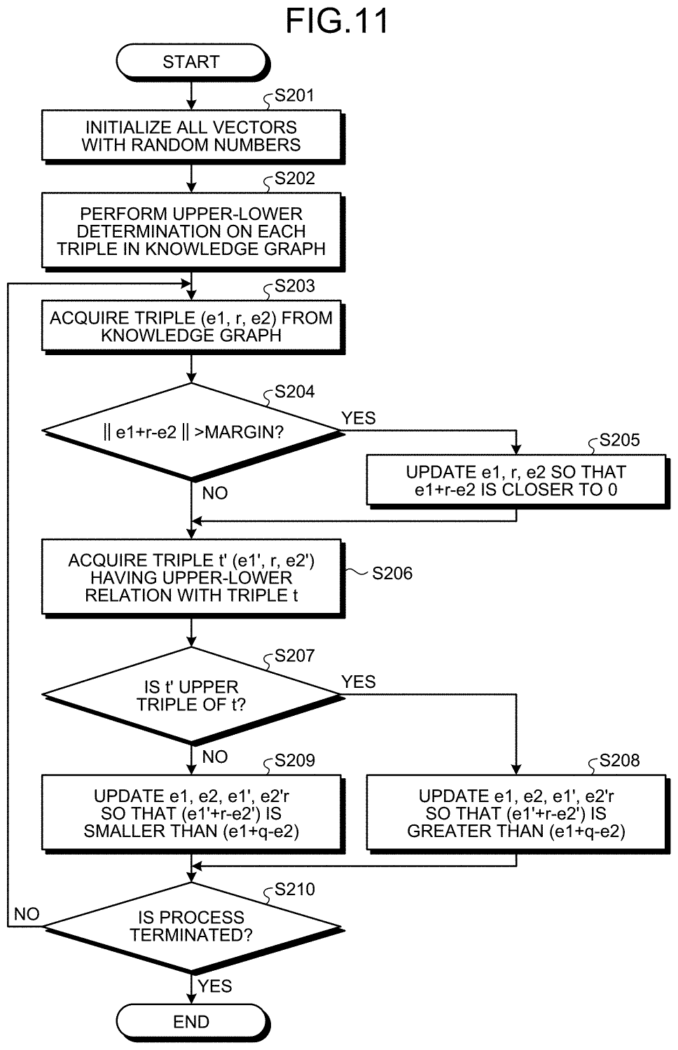

FIG. 11 is a flowchart illustrating the flow of a vector generation process according to the second example. As illustrated in FIG. 11, the determination unit 22 initializes all vectors in the knowledge graph with random numbers (S201), and performs an upper-lower determination on each triple in the knowledge graph on the basis of the class hierarchy (S202).

The generation unit 23 acquires a triple t (e1, r, e2) from the knowledge graph (S203), and determines whether the vector magnitude “∥e1+r−e2∥” of the triple t is greater than the threshold value (Margin) (S204).

When “∥e1+r−e2∥” is greater than the threshold value (Yes at S204), the generation unit 23 updates the vectors of “e1, r, e2” so that the vector difference (e1+r−e2) is closer to 0 (S205).

After S205 is performed or when “∥e1+r−e2∥” is less than the threshold value (No at S204), the generation unit 23 acquires a triple t′ (e1′, r, e2′) having an upper-lower relation with the triple t from the knowledge graph (S206).

When the triple t′ is an upper triple of the triple t (Yes at S207), the generation unit 23 updates the vectors of “e1, e2, e1′, e2′, r” so that the vector difference (e1′+r−e2′) is greater than the score of the vector difference (e1+r−e2) (S208).

On the other hand, when the triple t′ is a lower triple of the triple t (No at S207), the generation unit 23 updates the vectors of “e1, e2, e1′, e2′, r” so that the vector difference (e1′+r−e2′) is smaller than the score of the vector difference (e1+r−e2) (S209).

Subsequently, the generation unit 23 terminates the process when there is no vector to be updated or when the process has been repeated a prescribed number of times (Yes at S210). When there is a vector to be updated or when the number of times of execution is less than the prescribed number (No at S210), the generation unit 23 repeats S203 and subsequent steps.

As described above, the information processing apparatus 10 according to the second example can generate highly accurate vector representations by performing machine learning with an emphasis on a more specific relation between entities even though they are in the same relation.

Although the examples of the present invention have been described so far, the present invention may be carried out in various different forms in addition to the examples described above.

The knowledge graphs, entity examples, class examples, relation examples, numerical value examples, threshold values, display examples, and the like used in the above examples are merely examples, and can be changed as desired. The first method described in the first example and the method described in the second example can also be used in combination.

In each of the above examples, an example of performing machine learning using TransE has been described; however, the present invention is not limited thereto and other machine learning models can be employed. Therefore, flowcharts for the first example and the second example are described when a generic model is used.

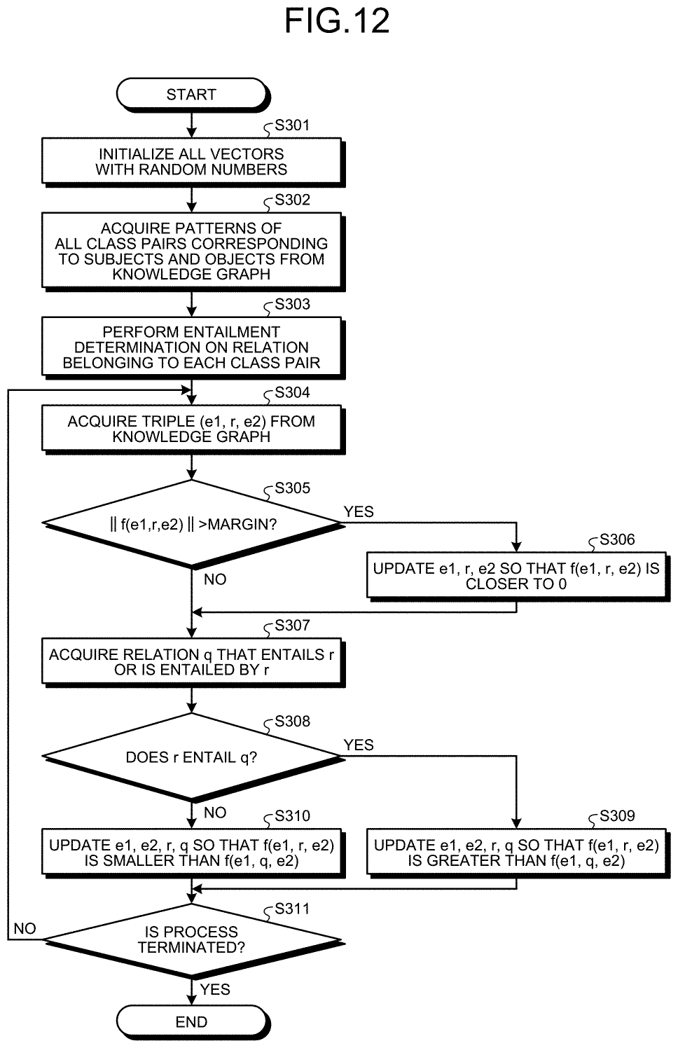

FIG. 12 is a flowchart illustrating the generic flow of the vector generation process using a class pair. In the processing flow illustrated in FIG. 12, the difference from FIG. 9 of the first example is that f(entity, relation, entity) is used as a score function. Various known functions can be used for the score function.

Specifically, S301 to S304 in FIG. 12 are the same as S101 to S104 in FIG. 9, so a detailed description thereof is omitted. The generation unit 23 determines whether a score function (f(e1, r, e2)) using the vector of the triple acquired from the knowledge graph is greater than the threshold value (Margin) (S305).

When the score function (f(e1, r, e2)) is greater than the threshold value (Yes at S305), the generation unit 23 updates the vectors of “e1, r, e2” so that the score function (f(e1, r, e2)) is closer to 0 (S306).

After S306 is performed or when the score function (f(e1, r, e2)) is less than the threshold value (No at S305), the generation unit 23 acquires the relation q that entails the relation r or is implied by the relation r (S307).

When the relation r entails the relation q (Yes at S308), the generation unit 23 updates the vectors of “e1, r, e2” so that the score function (f(e1, r, e2)) is greater than a score function (f(e1, q, e2)) (S309).

On the other hand, when the relation r does not entail the relation q (No at S308), the generation unit 23 updates the vectors of “e1, r, e2” so that the score function (f(e1, r, e2)) is smaller than the score function (f(e1, q, e2)) (S310).

Subsequently, the generation unit 23 terminates the process when there is no vector to be updated or when the process has been repeated a prescribed number of times (Yes at S311). When there is a vector to be updated or when the number of times of execution is less than the prescribed number (No at S311), the generation unit 23 repeats S304 and subsequent steps.

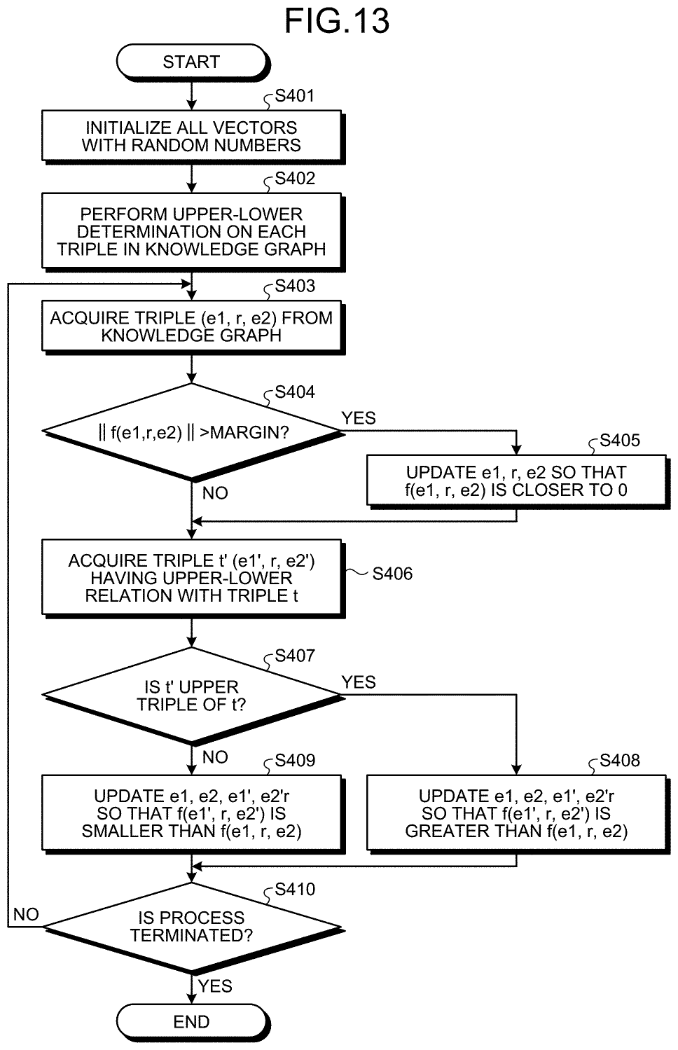

FIG. 13 is a flowchart illustrating the generic flow of the vector generation process using the class hierarchy. In the processing flow illustrated in FIG. 13, the difference from FIG. 11 of the second example is that f(entity, relation, entity) is used as a score function. Various known functions can be used for the score function.

Specifically, S401 to S403 in FIG. 13 are the same as S201 to S203 in FIG. 11, so a detailed description thereof is omitted. The generation unit 23 determines whether the score function (f(e1, r, e2)) using the vector of the triple acquired from the knowledge graph is greater than the threshold value (Margin) (S404).

When the score function (f(e1, r, e2)) is greater than the threshold value (Yes at S404), the generation unit 23 updates the vectors of “e1, r, e2” so that the score function (f(e1, r, e2)) is closer to 0 (S405).

After S405 is performed or when the score function (f(e1, r, e2)) is less than the threshold value (No at S404), the generation unit 23 acquires the triple t′ (e1′, r, e2′) having an upper-lower relation with the triple t from the knowledge graph (S406).

When the triple t′ is an upper triple of the triple t (Yes at S407), the generation unit 23 updates the vectors of “e1, e2, e1′, e2′, r” so that the score function (f(e1′, r, e2′)) is greater than the score function (f(e1, r, e2)) (S408).

On the other hand, when the triple t′ is a lower triple of the triple t (No at S407), the generation unit 23 updates the vectors of “e1, e2, e1′, e2′, r” so that the score function (f(e1′, r, e2′)) is smaller than the score function (f(e1, r, e2)) (S409).

Subsequently, the generation unit 23 terminates the process when there is no vector to be updated or when the process has been repeated a prescribed number of times (Yes at S410). When there is a vector to be updated or when the number of times of execution is less than the prescribed number (No at S410), the generation unit 23 repeats S403 and subsequent steps.

As described above, the information processing apparatus 10 can apply the above first method and second method to widely used machine learning models, thus improving versatility.

The processing procedures, control procedures, specific names, and information including various data and parameters illustrated in the above documents and drawings may be changed as desired, unless otherwise noted.

Furthermore, each component of each apparatus illustrated in the drawings is functionally conceptual and does not necessarily have to be physically configured as illustrated in the drawings. That is, specific forms of distribution and integration of the apparatuses are not limited to those illustrated in the drawings. In other words, all or some of the apparatuses can be functionally or physically distributed and integrated in desired units according to various loads, usage conditions, and the like.

Moreover, each processing function performed by each apparatus can be implemented in whole or in part by a CPU and a computer program that is analyzed and executed by the CPU, or as hardware using wired logic.

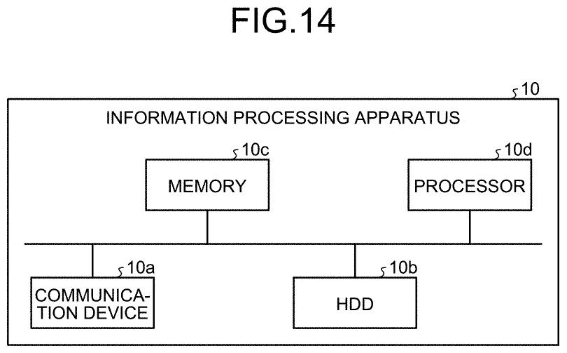

FIG. 14 is a diagram for explaining a hardware configuration example. As illustrated in FIG. 14, the information processing apparatus 10 includes a communication device 10a, a hard disk drive (HDD) 10b, a memory 10c, and a processor 10d. The parts illustrated in FIG. 14 are interconnected by a bus or the like.

The communication device 10a is a network interface card or the like, and communicates with other devices. The HDD 10b stores therein computer programs and DBs that operate the functions illustrated in FIG. 6.

The processor 10d reads, from the HDD 10b or the like, a computer program for executing the same process as that of each processing unit illustrated in FIG. 6, and loads the read computer program to the memory 10c, thereby operating the process of performing each function described in FIG. 6 and the like. For example, this process performs the same function as that of each processing unit included in the information processing apparatus 10. Specifically, the processor 10d reads, from the HDD 10b or the like, computer programs having the same functions as those of the acquisition unit 21, the determination unit 22, the generation unit 23, the prediction unit 24, and the like. Then, the processor 10d performs the same processes as those of the acquisition unit 21, the determination unit 22, the generation unit 23, the prediction unit 24, and the like.

In this way, the information processing apparatus 10 operates as an information processing apparatus that performs the machine learning method by reading and executing the computer programs. The information processing apparatus 10 can also read the above computer programs from a recording medium by a medium reading device and executes the read computer programs, thereby implementing the same functions as in the above examples. Note that other computer programs referred to in the examples are not limited to being executed by the information processing apparatus 10. For example, the present invention can be applied in the same way even when other computers or servers execute the computer programs or even when they execute the computer programs in cooperation with each other.

The computer program can be distributed via a network such as the Internet. The computer program can also be executed by being recorded on a computer-readable recording medium such as a hard disk, a flexible disk (FD), a CD-ROM, MO (Magneto-Optical disk), and a digital versatile disc (DVD) that can be read by a computer, and being read from the recording medium by the computer.

According to the embodiments, a highly accurate vector representation can be generated.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
specifying a first triple and a second triple included in a knowledge graph;
determining which of the first triple and the second triple is associated with more specific information on the basis of at least one of a first comparison and a second comparison, the first comparison being a comparison between a first relation between first two entities included in the first triple and a second relation between second two entities included in the second triple according to an occurrence status of each of a plurality of relations between a plurality of entities in a specific set of classes included in the knowledge graph, the second comparison being a comparison between a first entity connected to any one of the first two entities and a second entity connected to any one of the second two entities; and
when it is determined by the determining that the first triple is associated with the more specific information, generating vectors representing elements of the first triple and vectors representing elements of the second triple by machine learning based on a constraint that a difference in the vectors representing the elements of the first triple is smaller than a difference in the vectors representing the elements of the second triple.

2. The non-transitory computer-readable recording medium according to claim 1, wherein the determining includes, as the first comparison between the first relation and the second relation, determining which of the first triple and the second triple is associated with the more specific information by an entailment relation between the first relation and the second relation in the occurrence status in which, when the first relation exists between the entities in the specific set of classes, the second relation also exists.

3. The non-transitory computer-readable recording medium according to claim 2, wherein the determining includes
specifying, as the first comparison between the first relation and the second relation, a plurality of sets the first two entities having the first relation and a plurality of sets of the second two entities having the second relation from a plurality of triples belonging to the specific set of classes, and
determining that the first triple is associated with the more specific information when the plurality of sets of the first entities are included in the plurality of sets of the second two entities.

4. The non-transitory computer-readable recording medium according to claim 1, wherein the determining includes
specifying, as the second comparison between the first entity and the second entity, a first class to which the first entity belongs, and a second class to which the second entity belongs, on the basis of a hierarchical structure between classes to which entities included in the knowledge graph belong, and
determining that the first triple is associated with the more specific information, when the first class is located in a lower layer than the second class.

5. A machine training method comprising:
specifying a first triple and a second triple included in a knowledge graph;
determining which of the first triple and the second triple is associated with more specific information on the basis of at least one of a first comparison and a second comparison, the first comparison being a comparison between a first relation between first two entities included in the first triple and a second relation between second two entities included in the second triple according to an occurrence status of each of a plurality of relations between a plurality of entities in a specific set of classes included in the knowledge graph, the second comparison being a comparison between a first entity connected to any one of the first two entities and a second entity connected to any one of the second two entities; and
when it is determined by the determining that the first triple is associated with the more specific information, generating vectors representing elements of the first triple and vectors representing elements of the second triple by machine learning based on a constraint that a difference in the vectors representing the elements of the first triple is smaller than a difference in the vectors representing the elements of the second triple, using a processor.

6. An information processing apparatus comprising:
a memory; and
a processor coupled to the memory and configured to:
specify a first triple and a second triple included in a knowledge graph,
determine which of the first triple and the second triple is associated with more specific information on the basis of at least one of a first comparison and a second comparison, the first comparison being a comparison between a first relation between first two entities included in the first triple and a second relation between second two entities included in the second triple according to an occurrence status of each of a plurality of relations between a plurality of entities in a specific set of classes included in the knowledge graph, the second comparison being a comparison between a first entity connected to any one of the first two entities and a second entity connected to any one of the second two entities, and
when it is determined that the first triple is associated with the more specific information, generate vectors representing elements of the first triple and vectors representing elements of the second triple by machine learning based on a constraint that a difference in the vectors representing the elements of the first triple is smaller than a difference in the vectors representing the elements of the second triple.
